(19) United States
(12) Patent Application Publication
(10) Pub. No.: US 2010/0198662 A1
(43) Pub. Date: Aug. 5, 2010

(54) WEB SYSTEM AND METHOD FOR OUTCOME BASED ASSESSMENTS

(76) Inventors: Christopher E. Kalmus, LaGrange, IL (US); Robert Budnik, Naperville, IL (US)

Correspondence Address: MCANDREWS HELD & MALLOY, LTD, 500 WEST MADISON STREET, SUITE 3400, CHICAGO, IL, 60661, US

(21) Appl. No.: 12/699,746

(22) Filed: Feb. 3, 2010

Related U.S. Application Data
(60) Provisional application No. 61/150,289, filed on Feb. 5, 2009.

(51) Int. Cl. G06Q 10/00; G06F 21/24

(52) U.S. Cl. 705/11; 726/28

(57) ABSTRACT

A system and method provides outcome based assessments utilizing a web server system and database. The system collects evidence forming the basis of an assessment, ties a graded assessment to the underlying evidence and correlates the assessment with profile information of an institution, one or more groups within the institution, the assessor and the assessee and to a set of outcomes to generate aggregate and disaggregate reports so that performance at various levels within an institution relative to a set of outcomes can be determined.

### CROSS-REFERENCE TO RELATED APPLICATIONS/INCORPORATION BY REFERENCE

This application makes reference to, claims priority to and claims benefit from U.S. Provisional Application Ser. No. 61/150,289 filed on Feb. 5, 2009.

The above stated provisional application is hereby incorporated herein by reference in its entirety.

### STATEMENT REGARDING FEDERALLY SPONSORED RESEARCH OR DEVELOPMENT

N/A.

### FIELD OF THE INVENTION

The present invention is directed to assessment systems and methods and more particularly to a web system and method for outcome based assessments.

### BACKGROUND OF THE INVENTION

Various assessment systems and methods are known for evaluating an individual. In the context of student evaluations, systems are known that utilize ruberics to evaluate a student's mastery of a skill that has been taught in a class. A ruberic defines performance or accomplishment levels associated with a particular skill. A ruberic may or may not be tied to an outcome which is a high level goal. An example of an outcome is: to graduate students that are excellent communicators. A ruberic used in a writing class and tied to that outcome might assess a student's writing style with the following performance levels: Accomplished, Proficient, Partially Proficient, Not Accomplished. Such systems have allowed individual students to be evaluated or all students in a class to be evaluated to determine the percentage of students falling within each performance level. However, such systems have not been able to provide accurate reports on performance relative to, for example, a university or school outcome.

Other assessment systems such as testing services have been known to collect limited profile information such as name, gender, ethnicity, etc., regarding an individual taking a test. However, these tests while attempting to measure a skill are not tied to one or more outcomes of the test takers institution, e.g. university or corporation. As such, these tests measure skills that the testing service wants to measure and that may not be related to the outcomes of the test taker's institution. Besides being limited to a narrow set of skills or characteristics being tested, these testing services only provide a snapshot of an individual's abilities on the day that the test was taken. As such, these testing services cannot provide an assessment of an individual as a whole. Nor, can these systems provide explanations of anomalies in an individual's performance.

### BRIEF SUMMARY OF THE INVENTION

In accordance with the present invention, the disadvantages of prior assessment systems and methods have been overcome. The system and method of the present invention provide outcome based assessments utilizing a web server system and data base. The assessment system and method provide transparency and accountability and further enable continuous improvements to be made at all levels of an institution.

In accordance with one embodiment of the present invention, the system collects evidence, i.e. the work product of the assessee that forms the basis of the assessment. The evidence is tied to the assessment in the system so that the assessment itself can be verified. The assessment performed utilizes different types of assessment instruments, such as ruberics, test, etc., wherein the assessment instruments are tied to a set of outcomes generated at a number of different levels within an institution. The system of the present invention allows feedback to be given by the assessor to the assessee wherein the interactions between the assessee and the assessor are captured and stored by the system. These interactions are also monitored so that the system can generate data about the interactions that have occurred between the assessee and assessor. The information that has been captured and generated by the assessment process is than correlated and analyzed to provide reports by outcome, by individual assessee, by program, by institution, or by group or subgroup within the institution. As such, the analysis by the system is used to generate aggregate as well as disaggregate reports illustrating performance at a number of different levels relative to the set of outcomes.

The system and method of the present invention allows continuous improvements to be made at all levels within an institution. For example, the system allows programs to be improved, training and learning improvements, improvements in planning and research, etc. as well as refinements of the assessment process itself.

In accordance with another feature of the present invention, an assessment method implemented by a web based server system having a data base includes collecting profile information for a number of different entities including an assessee, an assessor, at least one group to which the assessor and assessee belong, an institution to which at least one group belongs, and a group of like or diverse institutions. The method also includes receiving a gradable assessment instrument mapped to a set of outcomes and transmitting the gradable assessment instrument for an assessee to an assessor. A number of graded assessment instruments for a respective number of assessees from a plurality of assessors are received and collected by the system. The collected and received information is then stored in a data base. The method also includes correlating graded assessment information and profile information with a plurality of outcomes to generate aggregate and disaggregate reports illustrating performance at a plurality of levels relative to the set of outcomes.

In accordance with another embodiment of the present invention, the method includes receiving assessee evidence that is mapped to an assessment instrument and correlating the received evidence to one or more outcomes in a set. The method also includes providing access by authorized individuals to assessee evidence mapped to an assessment instrument upon which a report is generated through the report itself and blocking selected profile information for an assessee from being accessed through the report.

In accordance with a further feature of the invention, the method includes transmitting assessee evidence to an assessor for comment; receiving an assessor's comments mapped to an assessee's evidence; transmitting the assessor's comments mapped to the assessee's evidence back to the assessee; receiving a resubmission of the assessee's evidence; storing a history of an assessee's submitted and resubmitted evidence mapped to the assessor's comments and generating data about the interaction between the assessee and assessor.

In accordance with a further feature of the present invention, the system and method allows the assessee to assess or evaluate the assessor wherein the assessee's evaluation of the assessor is tied to the assessor's evaluation of the assessee. In this manner, problems stemming from miscommunications and/or misapprehension of expectations can be uncovered.

The system and method of the present invention further collects profile information from third parties and is capable of transmitting a gradable assessment instrument to a third party for grading by the third party. The system receives a number of graded assessment instruments from third parties, stores the received graded assessment instruments from the third parties in a data base and correlates the third party assessment information with one or more outcomes to generate a report. In this manner, the outcomes of the institution are evaluated not only from within the institution but from outside of the institution as well.

These and other advantages and novel features of the present invention, as well as details of an illustrated embodiment thereof will be more fully understood from the following description in the drawings.

### BRIEF DESCRIPTION OF SEVERAL VIEWS OF THE DRAWINGS

FIG. 1 is a diagram illustrating the various processes implemented by the web, outcome based assessment system of the present invention;

FIG. 2 is a block diagram illustrating the web, outcome based assessment system of FIG. 1 communicating with a number of entities within a number of various institutions and with third parties; and

FIG. 3 is a illustration of the various entities within and outside of a number of institutions for which profile information, evidence, and assessment information is gathered for analysis by the system of FIG. 2.

### DETAILED DESCRIPTION OF THE INVENTION

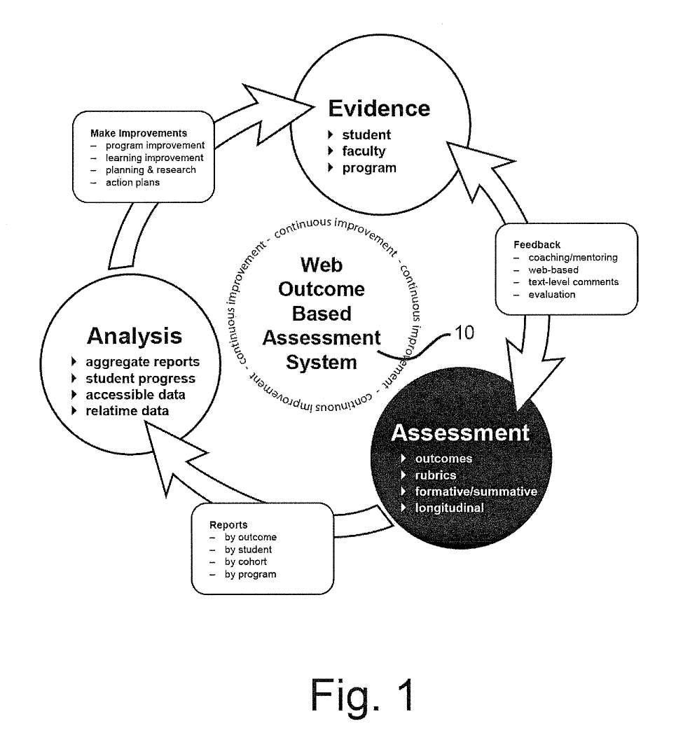

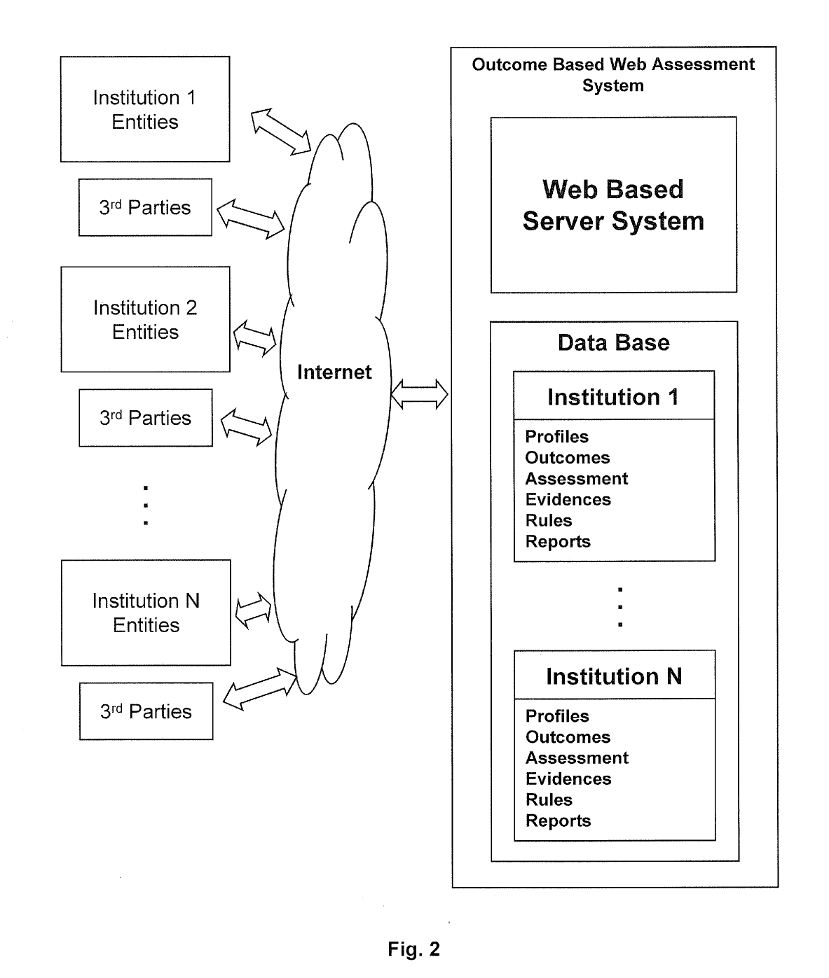

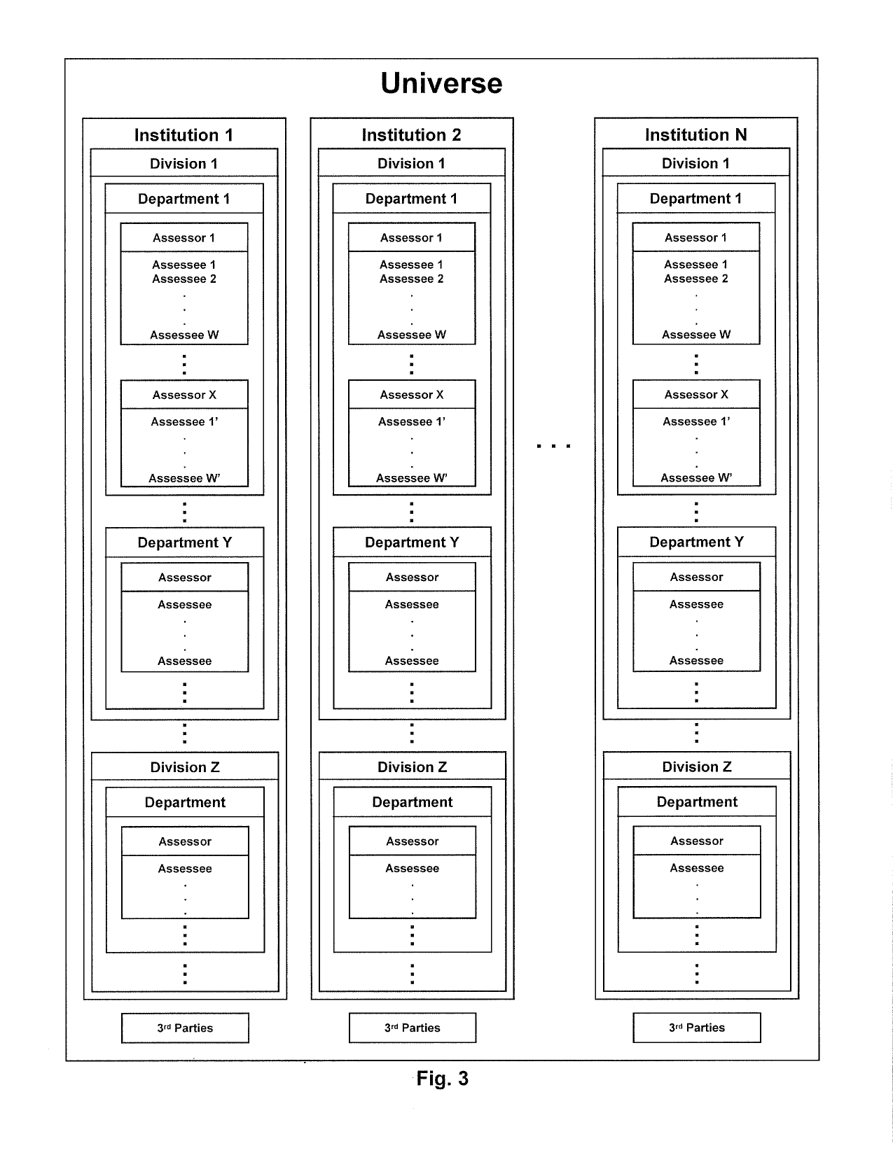

The system 10 of the present invention, as shown in FIGS. 1 and 2, utilizes a web-based server system 12 and database 14 for providing outcome based assessments via interactions with a number of different entities from within various institutions and interactions with third parties outside of the institutions. The institutions may be corporations, universities or schools, government agencies, hospitals or healthcare systems, etc. As shown in FIG. 3, within each of the various institutions, there are divisions, which may be a business division, corporate subsidiary, college within a university, government agency division, particular hospital or healthcare clinic, etc. Further, within each division are a number of departments which can include a product development department, marketing department, department within a university's college, department within a division of a government agency, cardiac healthcare department, internal medicine department, testing department, etc. Further, within each department there are managers or designated individuals that provide assessments of other employees, students, programs, products, etc. The individual providing the evaluation or assessment is referred to as an assessor. The employee, student, program, product, etc. being evaluated is designated as the assessee.

During a setup and configuration process, the system 10 gathers profile data about each institution as well as each division and department within a given institution. The system 10 also collects data providing a profile of each program and/or course involved in the assessment process as well as profile data for the assessor and assessees. Profile data of third parties that are going to take part in the assessment process is collected as well. This profile data is then stored in the database 14 for the various institutions. During the setup and configuration process, a set of outcomes is generated and stored in the database 14 for each of the institution's entities. More particularly, a set of outcomes is defined and stored for the institution; a set of outcomes is defined and stored for each division within the institution and for each department within each division of the institution. Respective sets of outcomes are also generated and stored for the assessor and for the assessee as well as for each third party. An outcome is generally a high-level goal or standard. As such, the set of outcomes for an institution, and the divisions, departments, assessors and assessees of the institution will typically overlap but may be diverse. Outcomes are also generated and stored for third parties. Next, an assessment instrument is created for an assessor to use in evaluating an assessee. Assessment instruments can also be created for assessees to use to evaluate the assessor and for third parties to use to evaluate the assessee, assessor, program, product, or institution as a whole. Once the various assessment instruments are generated each instrument is mapped to one or more outcomes.

In a preferred embodiment of the present invention, the system 10 collects evidence, i.e. the work product of the assessee that forms the basis of the assessment. The evidence is then tied to assessment or a particular assessment instrument in the system. For example, an assessee will interact with the system 10 via a computer e.g. a person computer, laptop, etc. When the assessee logs onto the system of present invention via the internet, the web-based server 12 may prompt the assessee to enter a work product that the assessee has produced which work product will form the basis or part of the basis for the assessment. Once this information is entered by the assessee, the web-based system 10 ties the evidence to an assessment instrument.

An assessment instrument is created using the system 10 such that the web-based server 12 prompts an individual within an institution to enter requested information defining the assessment instrument via a template provided by the web-based server 12. For example, if an assessment instrument is a ruberic, the system 10 will prompt the creator of the assessment instrument to enter the name of the ruberic, the skill being evaluated, and the various performance levels to be used to grade the assessee's skill. The system 10 also preferably displays the various outcomes that have been created for all of the entities in the institution and allows the creator of the assessment instrument to select which outcomes are to be tied to the particular assessment instrument. When the assessment system 10 receives a gradable assessment instrument from a user, the system 10 maps the assessment instrument in the database 14 with the set of outcomes identified.

When an assessment is to take place, an assessor requests a particular assessment instrument from the assessment system 10. The system 10 transmits to the assessor the gradable assessment instrument along with the evidence submitted by the assessee and associated and tied to the assessment instrument. The assessment instrument viewed by the assessor thus includes the evidence, i.e. the work product being evaluated to assess the assessee as well as the ruberics to be used. Once the assessor has evaluated the assessee using the assessee's evidence and the assessment instrument, the assessor transmits the graded assessment instrument to the system 10. The system 10 collects and stores the graded assessment instruments from all assessors for all assessees within an institution wherein the information is stored in the database 14.

The system 10 analyzes the stored assessment information and correlates graded assessment information and profile information with various outcomes to generate aggregate as well as disaggregate reports illustrating the performance at various levels within the institution, e.g. at the institution level, department level, program or course level, assessor level, assessee level, etc. relative to the various sets of outcomes. As such, the system and method of the present invention not only allows an individual to be assessed, but allows a department, division or the institution as a whole to be assessed relative to the department's, division's, or institution's desired outcomes.

In accordance with one embodiment of the present invention, the system 10 allows an assessee to create a draft or non-final work product in association with an assessment instrument that is submitted to the system 10. An assessor can access the non-final work product and provide comments directly on the work product. The assessor sends the non-final work product with added comments to the system 10. The system 10 then prompts the assessee for a resubmission of the work product based on the assessor's comments. The system 10 stores each submission and associated comments to provide a history of the interaction between the assessee and assessor on a given project. Moreover the system 10 monitors the interactions between the assessee and the assessor to generate data regarding the interactions. For example, the system 10 generates data regarding the number of draft submissions made; the amount of feedback provided; the length of time from the first submission to the final submission; the amount of time between a submission and the comments or feedback from the assessor; and the amount of time between the comments provided by the assessor and the following version of the work product submitted by the assessee. By monitoring the interactions between assessor and assessee, a more transparent view of the assessment process can be obtained then has heretofore been possible. The generated data enables inefficiencies as well as effort and progress on a particular project to be evaluated.

The system 10 also allows third parties to provide assessments of an assessee, which as discussed above, can be an employee of the institution, a project, a process, a product or a service provided by an institution. The third party may be, for example, a vendor, supplier, customer, accreditation agency, etc. Unlike prior systems that merely send surveys to third parties and compile the results, the system 10 maps the third party assessment to work product and/or a set of outcomes defined by various entities of the institution. If a negative assessment is provided by a third party, the institution can immediately see the work product which elicited the negative evaluation so that improvements at various levels within the institution can be made. As such, the system of the present invention enables a much more meaningful analysis of collected information to be performed.

During the analysis stage of the assessment process, the system 10 correlates evidence, assessment and profile information with outcomes to provide aggregate and disaggregate reports. Using a report generated by the system 10, a user can view any of the underlying information upon which the report is based, and for which the user has authorization to view, by the user merely selecting highlighted information in the report. As such, an individual reviewing a report directed to an institution's performance as related to a set of outcomes can view the actual work product of the assessees upon which the assessment or evaluation is based.

Moreover, the system 10 allows reports to be generated to depict one institution's performance relative to other like or diverse institutions. When such reports are generated, the system 10 blocks the names of entities of and within other institutions as well as any confidential underlying information of those institutions. Readily available relative performance information can provide a timely incentive to improve an institution's performance. As such, the system of the present invention enables continuous improvement and provides a continuous incentive for an institution to make improvements.

Many modifications and variations of the present invention are possible in light of the above teachings. Thus, it is to be understood that the invention may be practiced otherwise then as described hereinabove.

What is claimed is:

1. An assessment method implemented by an assessment system having an internet-based server and a database coupled thereto, comprising:
collecting a work product by an assessee who is a part of an institution;
tying the work product to an assessment performed by an assessor utilizing an assessment instrument wherein the assessment instrument is tied to a set of outcomes associated with the institution;
capturing interactions between the assessor and assessee for storage in the database in association with the assessment;
generating data about the interactions that have occurred between the assessee and assessor; and
correlating the information captured and generated during the assessment process to generate aggregate and disaggregate reports regarding performance of the institution or a part thereof.

2. The method of claim 1 including the step of generating a plurality of reports on performance at a number of different levels relative to the set of outcomes.

3. The method of claim 1 including:
collecting profile information for storage in the database on the assessee, assessor and a group within the institution to which the assessee and assessor belong; and
correlating assessment information and profile information with a plurality of outcomes from the set of outcomes to generate reports.

4. The method of claim 3 including:
collecting profile information on the institution to which the group belongs and a group of like or diverse institutions.

5. The method of claim 1 including:
correlating collected work product to at least one outcome of the set;
providing access by an authorized individual to an assessee's work product tied to an assessment instrument used to generate a report through the report itself; and
blocking selected profile information for an assessee from being accessed through the report.

6. The method of claim 1 including:
transmitting assessee work product to an accessor for comment;
receiving an assessor's comments mapped to the assessee's work product;
transmitting the assessor's comments mapped to the assessee's work product to the assessee;
receiving a resubmission of the assessee's work product;
storing a history of an assessee's submitted and resubmitted evidence mapped to the assessor's comments, wherein the data about the interaction between the assessee and assessor is generated from the stored history.

7. The method of claim 1 including:
collecting an assessment from the assessee evaluating the assessor; and
tying the assessee's assessment of the assessor to the assessor's assessment of the assessee.

8. The method of claim 1 including:
collecting profile information from a plurality of third parties;
transmitting a gradable assessment instrument for an institution or member thereof to a plurality of the third parties for grading;
receiving a graded assessment from a plurality of the third parties and
correlating the third parties' assessment information with one or more outcomes of the set to generate a report.
